(19) United States
(12) Patent Application Publication
(10) Pub. No.: US 2025/0389232 A1
(43) Pub. Date: Dec. 25, 2025

(54) ENGINE CONTROLLER

(71) Applicant: SUBARU CORPORATION, Tokyo (JP)

(72) Inventor: Takumi MURATA, Tokyo (JP)

(21) Appl. No.: 19/228,870

(22) Filed: Jun. 5, 2025

(30) Foreign Application Priority Data
Jun. 25, 2024 (JP) 2024-101881

(51) Int. Cl. F02D 41/00; F02P 5/15

(52) U.S. Cl. CPC F02D 41/0052; F02D 41/0077; F02P 5/1516; F02D 2200/0404; F02D 2200/1002

(57) ABSTRACT

An engine controller includes an exhaust gas recirculation valve, a fuel injection device, an ignition device, and a controller including a processor. The processor includes a requested torque setter, a surplus torque setter, a comparator, and a correction torque setter. The requested torque setter sets requested torque, on the occasion of restoration from fuel cut. The surplus torque setter sets, on the occasion of the restoration from the fuel cut, surplus torque in combustion based on a flow rate of the air to pass through the exhaust gas recirculation valve. The comparator makes a comparison between the requested torque and the surplus torque. The correction torque setter sets, based on a result of the comparison, correction torque to correct the amount of the air to pass through a throttle valve and to make retard correction of ignition timing.

### CROSS-REFERENCE TO RELATED APPLICATIONS

The present application claims priority from Japanese Patent Application No. 2024-101881 filed on Jun. 25, 2024, the entire contents of which are hereby incorporated by reference.

### BACKGROUND

The disclosure relates to an engine controller configured to control an engine on the occasion of restoration from fuel cut.

One of the engine control systems for engines mounted on vehicles is an exhaust gas recirculation (EGR) device. An EGR device is configured to recirculate a part of an exhaust gas into the intake air for re-combustion in a combustion chamber. This makes it possible to improve fuel consumption and suppress a combustion temperature to reduce generation of nitrogen oxides (NOx).

An EGR device includes an EGR passage. The EGR passage serves as a bypass between an exhaust passage and an intake passage of an engine. On the EGR passage, an EGR valve is provided. A controller is configured to control a degree of opening of the EGR valve to control an amount of EGR to be supplied to the intake passage.

When the EGR valve has an operation failure or the EGR passage is clogged, an air-fuel ratio may go out of order. This results in unstable combustion, causing deterioration in exhaust gas emission. Thus, various proposals have been made for techniques of checking a state of the EGR device while the vehicle is traveling, making a failure diagnosis of the EGR device, and performing EGR learning including learning variations and aging of the EGR valve. In the following, the failure diagnosis of the EGR device is referred to as an “EGR failure diagnosis.”

The EGR failure diagnosis and the EGR learning are often performed during fuel cut while the vehicle is traveling. In the following, the EGR failure diagnosis and the EGR learning are referred to as “EGR learning/diagnosis.” The EGR learning/diagnosis includes compulsively opening and closing the EGR valve during the fuel cut, and detecting changes in an amount of the intake air by an intake air flow sensor or an intake pipe pressure sensor provided on the intake passage. The EGR learning/diagnosis further includes determining whether the EGR device is in normal operation based on whether an increase or decrease in the amount of the intake air corresponding to an increase or decrease in the amount of EGR caused by the opening or closing of the EGR valve is detected.

During the fuel cut, the fresh air is supplied into the cylinder. When the EGR learning/diagnosis is made on this condition, an EGR gas to be supplied from the EGR passage to an intake system also includes only the fresh air.

In the EGR learning/diagnosis during the fuel cut, filling efficiency becomes higher by an amount of the EGR gas supplied into the cylinder, i.e., the fresh air. This results in the excessive air. Accordingly, when restoration from the fuel cut is made during or immediately after the EGR learning/diagnosis, engine torque becomes excessive by an amount of the excessive air, causing a torque level difference. The torque level difference causes fluctuation of a longitudinal acceleration rate acting on a vehicle body, giving a driver the sense of torque shock.

For example, in Japanese Unexamined Patent Application Publication (JP-A) No. 2015-158198, on the occasion of normal restoration from the fuel cut, a retard control of ignition timing is made to alleviate the torque shock accompanying a restart of combustion. JP-A No. 2015-158198 also discloses a technique in which, when elapsed time from an end of the EGR learning/diagnosis to the restoration from the fuel-cut is short, the ignition timing by the retard control is set to more advanced side than normal.

### SUMMARY

An aspect of the disclosure provides an engine controller including an exhaust gas recirculation valve, a fuel injection device, an ignition device, and a controller. The exhaust gas recirculation valve is provided on an exhaust gas recirculation passage in an exhaust gas recirculation device. The exhaust gas recirculation passage serves as a bypass between an exhaust passage and an intake passage of an engine. The fuel injection device is configured to inject fuel into a cylinder of the engine. The ignition device is configured to ignite, at predetermined ignition timing, a spark plug of the engine faced with an inside of the cylinder. The controller is configured to compulsively open and close the exhaust gas recirculation valve during fuel cut, to perform learning and diagnosis of the exhaust gas recirculation device. The controller is configured to detect restoration from the fuel cut. The controller is configured to, on the occasion of the restoration from the fuel cut, make a retard control of the ignition timing, a control of an amount of the air to pass through a throttle valve, and a control of a degree of opening of the exhaust gas recirculation valve. The controller includes a processor configured to calculate torque on the occasion of the restoration from the fuel cut during or after the learning and the diagnosis of the exhaust gas recirculation device. The processor includes a request torque setter, a surplus torque setter, a comparator, and a correction torque setter. The requested torque setter is configured to, on the occasion of the restoration from the fuel cut, set requested torque as engine torque requested by a driver. The surplus torque setter is configured to, on the occasion of the restoration from the fuel cut, set surplus torque in combustion based on a flow rate of the air to pass through the exhaust gas recirculation valve. The comparator is configured to make a comparison between the requested torque set by the requested torque setter and the surplus torque set by the surplus torque setter. The correction torque setter is configured to set, based on a result of the comparison by the comparator, correction torque to correct the amount of the air to pass through the throttle valve and to make retard correction of the ignition timing.

An aspect of the disclosure provides an engine controller including an exhaust gas recirculation valve, a fuel injection device, an ignition device, and circuitry. The exhaust gas recirculation valve is provided on an exhaust gas recirculation passage in an exhaust gas recirculation device. The exhaust gas recirculation passage serves as a bypass between an exhaust passage and an intake passage of an engine. The fuel injection device is configured to inject fuel into a cylinder of the engine. The ignition device is configured to ignite, at predetermined ignition timing, a spark plug of the engine faced with an inside of the cylinder. The circuitry is configured to compulsively open and close the exhaust gas recirculation valve during fuel cut, to perform learning and diagnosis of the exhaust gas recirculation device. The circuitry is configured to detect restoration from the fuel cut. The circuitry is configured to, on the occasion of the restoration from the fuel cut, make a retard control of the ignition timing, a control of an amount of the air to pass through a throttle valve, and a control of a degree of opening of the exhaust gas recirculation valve. The circuitry is configured to calculate torque on the occasion of the restoration from the fuel cut during or after the learning and the diagnosis of the exhaust gas recirculation device. The circuitry is configured to, on the occasion of the restoration from the fuel cut, set requested torque as engine torque requested by a driver. The circuitry is configured to, on the occasion of the restoration from the fuel cut, set surplus torque in combustion based on a flow rate of the air to pass through the exhaust gas recirculation valve. The circuitry is configured to make a comparison between the requested torque and the surplus torque. The circuitry is configured to set, based on a result of the comparison, correction torque to correct the amount of the air to pass through the throttle valve and to make retard correction of the ignition timing.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic diagram of an overall configuration of an engine.

FIG. 2 is a block diagram of a schematic configuration of an engine control unit.

FIG. 3 is a configuration diagram of a processor of corrected torque and EGR secondary valve opening.

FIG. 4 is a conceptual graph of a surplus torque table.

FIG. 5 is a conceptual graph of a requested torque map.

FIG. 6 is a conceptual graph of an EGR secondary valve opening map.

### DETAILED DESCRIPTION

In the technique disclosed in JP-A No. 2015-158198, on the occasion of the restoration from the fuel cut immediately after the end of the EGR learning/diagnosis, the ignition timing by the retard control is set to the more advanced side than normal. This may cause a sudden rise in the engine torque immediately after the restoration from the fuel cut. In the technique disclosed in JP-A No. 2015-158198, it is difficult to radically reduce the excessive torque accompanying the excessive fresh air.

It is desirable to provide an engine controller that makes it possible to, on the occasion of restoration from fuel cut during which EGR learning/diagnosis is made, alleviate a torque level difference caused by a sudden rise in engine torque and reduce a torque shock to be felt by a driver.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

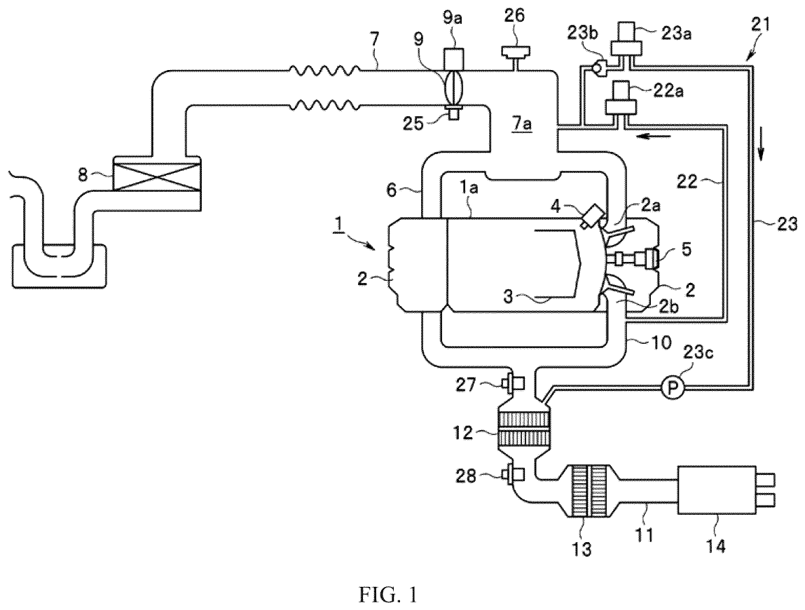

FIG. 1 illustrates a horizontally opposed four-cycle gasoline engine as an example of an engine 1. The engine 1 may include cylinder heads 2. The cylinder heads 2 may be provided on right and left banks of the engine 1. The cylinder heads 2 may each include an intake port 2a and an exhaust port 2b. In the cylinder head 2, a combustion chamber may be formed by compression of a piston 3 provided in each cylinder. To the cylinder head 2, a direct injection injector 4 and a spark plug 5 may be attached for each cylinder. The direct injection injector 4 may perform direct fuel injection into the combustion chamber. A tip of the spark plug 5 may be faced with the combustion chamber.

Upstream portions of the intake ports 2a on the right and left banks may be joined together through an intake manifold 6. The joint portion through the intake manifold 6 may communicate with an air chamber 7a. The air chamber 7a may constitute a part of an intake passage downstream of an intake pipe 7. On air-intake side upstream of the intake pipe 7, an air cleaner 8 may be provided. On the way of the intake pipe 7, a throttle valve 9 may be provided. The throttle valve 9 may include an electronically controlled throttle valve. The throttle valve 9 may be driven to open and close by turning of a throttle actuator 9a.

The exhaust ports 2b on the cylinder heads 2 on the right and left banks may be joined together through an exhaust manifold 10. The joint portion through the exhaust manifold 10 may communicate with an exhaust pipe 11 as an exhaust passage. Downstream of the joint portion on the exhaust pipe 11, an exhaust purification catalyst 12 may be provided. Downstream of the exhaust purification catalyst 12 on the exhaust pipe 11, a gasoline particulate filter (GPF) 13 may be provided. The exhaust purification catalyst 12 is configured to clean harmful gas components in the exhaust gas. The GPF 13 is configured to collect particulate matters (PM) contained in the exhaust gas. Furthermore, a muffler 14 may be attached to a downstream end of the exhaust pipe 11.

An exhaust gas recirculation (EGR) device 21 may include an EGR primary passage 22 and an EGR secondary passage 23. The EGR primary passage 22 may allow the exhaust pipe 11 and the air chamber 7a to communicate with each other. The EGR secondary passage 23 may include an upstream end and a downstream end. The downstream end of the EGR secondary passage 23 may communicate directly upstream of the exhaust purification catalyst 12 provided on the exhaust pipe 11. The upstream end of the EGR secondary passage 23 may communicate with a downstream portion of the EGR primary passage 22, i.e., the air chamber 7a side of the EGR primary passage 22.

The EGR primary passage 22 is configured to recirculate a part of the exhaust gas flowing into the exhaust pipe 11 to the air chamber 7a using differential pressure. The EGR secondary passage 23 is configured to return, to the exhaust pipe 11, a part of an EGR gas, e.g., the air, to be recirculated to the air chamber 7a from the EGR primary passage 22 immediately after restoration from fuel cut.

On the EGR primary passage 22, an EGR primary valve 22a may be provided. The EGR primary valve 22a may be provided upstream of a portion where the EGR secondary passage 23 communicates with the EGR primary passage 22. On the EGR secondary passage 23, an EGR secondary valve 23a may be provided. Moreover, a check valve 23b may be provided upstream of the EGR secondary valve 23a, on the EGR secondary passage 23. The check valve 23b is configured to block a flow of the exhaust gas from the EGR secondary valve 23a side toward the EGR primary passage 22.

Furthermore, an electric pump 23c may be provided downstream of the EGR secondary valve 23a, on the EGR secondary passage 23. Degrees of opening of the EGR valves 22a and 23a may be freely set by, for example, a stepping motor. The degrees of opening of the EGR valves 22a and 23a, and turning ON/OFF of the electric pump 23c may be controlled by an engine control unit (E/G_ECU) 31 described later. In one embodiment of the disclosure, the E/G ECU 31 may serve as a “controller.” The electric pump 23c may lead the EGR gas in the downstream portion of the EGR primary passage 22 to the EGR secondary passage 23 and discharge the EGR gas directly upstream of the exhaust purification catalyst 12 on the exhaust pipe 11.

Description is given next of arrangement of sensors configured to detect various parameters to be involved in an EGR control. To the throttle valve 9, a throttle position sensor 25 may be coupled. The throttle position sensor 25 may detect a throttle plate position. With the air chamber 7a, an intake pipe pressure sensor 26 may communicate. The intake pipe pressure sensor 26 may detect intake pipe pressure in the air chamber 7a by absolute pressure.

An air-fuel ratio (A/F) sensor 27 may be provided upstream of the exhaust purification catalyst 12 on the exhaust pipe 11. An oxygen (O₂) sensor 28 may be provided downstream of the exhaust purification catalyst 12. The A/F sensor 27 may detect an air-fuel ratio (A/F) in the exhaust gas. The oxygen sensor 28 may detect an oxygen concentration in the exhaust gas that has passed through the exhaust purification catalyst 12. Although unillustrated in FIG. 1, other sensors may include, for example, an accelerator opening sensor 29 and an engine speed sensor 30. The accelerator opening sensor 29 may detect an amount of stepping down of an accelerator pedal. The accelerator pedal is to be operated by a driver. The engine speed sensor 30 may detect an engine speed.

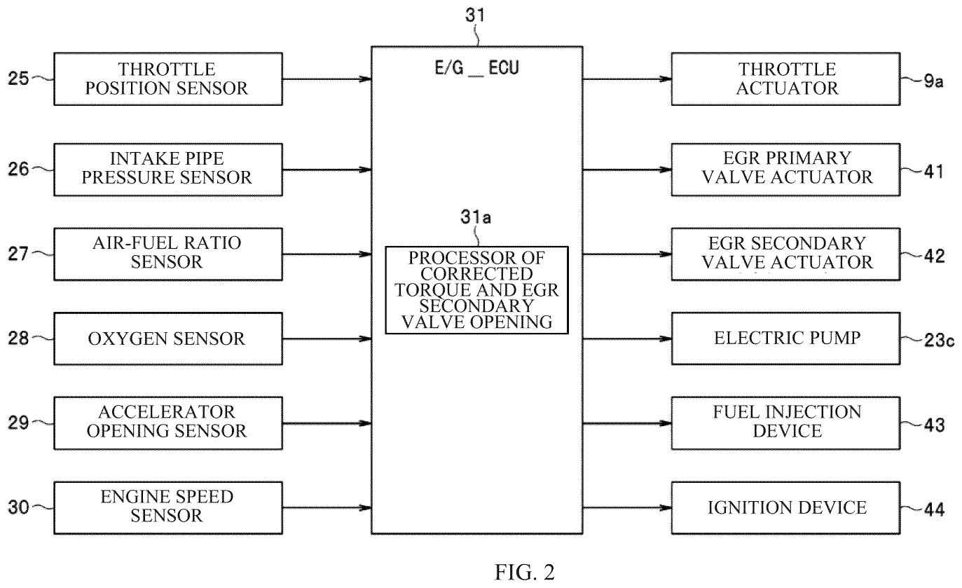

Referring to FIG. 2, the E/G_ECU 31 may include, for example, a microcontroller including a CPU (Central Processing Unit), a RAM (Random Access Memory), a ROM (Read Only Memory), a rewritable nonvolatile memory such as a flash memory or an EEPROM (Electrically Erasable and Programmable Read Only Memory), and peripheral devices. The RAM may serve as a work area for the CPU, and temporarily hold various kinds of data for the CPU. The ROM may hold programs, fixed data, and the like necessary for the CPU to perform processing. The CPU is also referred to as an MPU (Microprocessor) or a processor. Instead of the CPU, a GPU (Graphics Processing Unit) or a GSP (Graph Streaming Processor) may be used. Alternatively, the CPU, the GPU, and the GSP may be selectively used in combination.

The sensors 25 to 30 described above may be coupled to input side of the E/G_ECU 31. To output side of the E/G_ECU 31, the throttle actuator 9a and the electric pump 23c may be coupled. Furthermore, an EGR primary valve actuator 41, an EGR secondary valve actuator 42, a fuel injection device 43, and an ignition device 44 may be coupled. The EGR primary valve actuator 41 may drive the EGR primary valve 22a. The EGR secondary valve actuator 42 may drive the EGR secondary valve 23a. The fuel injection device 43 may drive the direct injection injector 4 at predetermined injection timing to inject a predetermined amount of fuel into the cylinder. The ignition device 44 may drive the spark plug 5 at predetermined timing to cause ignition. In the embodiment, the valve actuators 41 and 42 may each include a stepping motor.

The E/G ECU 31 is configured to make an ignition timing control, a fuel injection control, and an EGR control while the vehicle is traveling. In addition, the E/G_ECU 31 is configured to make a fuel cut control. The EGR control includes, when an EGR control condition is established, setting a flow rate (m³/sec), i.e., a volume flow rate, of the EGR gas to be supplied to each cylinder in accordance with a driving condition of the engine 1. The E/G_ECU 31 may drive the EGR primary valve actuator 41 to control the degree of opening, i.e., the number of steps, of the EGR primary valve 22a, and supply the EGR gas of the set flow rate to the air chamber 7a. The EGR secondary valve 23a may open on the occasion of the restoration from the fuel cut, and normally maintain a fully closed state.

The fuel cut control includes temporarily stopping the fuel injection when a fuel cut condition is established. The fuel cut condition includes, for example, deceleration because of release of the acceleration pedal or compulsive braking. When the fuel cut is made, the E/G_ECU 31 may fully close the EGR primary valve 22a to shut off the supply of the EGR gas to the cylinder. As a result, only the fresh air that has passed through the throttle valve 9, i.e., the throttle-passing air, is supplied to each cylinder.

Furthermore, the E/G_ECU 31 may make EGR learning/diagnosis. The EGR learning/diagnosis includes checking a state of the EGR device 21 on the occasion of the fuel cut while the vehicle is traveling. At a start of the EGR learning/diagnosis, first, the EGR primary valve 22a in the fully closed state is gradually fully opened. In the meantime, the E/G ECU 31 may read the intake pipe pressure detected by the intake pipe pressure sensor 26. The E/G ECU 31 may check whether the EGR primary valve 22a is in normal operation, based on fluctuation of the intake pipe pressure detected by the intake pipe pressure sensor 26 and accompanying the opening operation of the EGR primary valve 22a.

In the EGR learning/diagnosis during the fuel cut while the vehicle is traveling, the EGR primary valve 22a is once fully closed and afterwards, fully opened. When the EGR primary valve 22a is opened, each cylinder is supplied with not only the throttle-passing air but also the EGR gas from the EGR primary passage 22. Because the cylinder during the fuel cut is filled with only the air, the EGR gas to be supplied to the cylinder also includes only the air. Accordingly, the intake air flow rate (m³/s) to be supplied into the cylinder becomes a total air flow rate Qtotal (m³/s) obtained by adding an EGR flow rate Qegr supplied from the EGR primary passage 22 to a throttle-passing air flow rate Qthr. Thus, filling efficiency of the cylinder with the air becomes higher, by the EGR flow rate Qegr, than before the start of the EGR learning/diagnosis. That is, the filling efficiency becomes a state with the excessive air.

Thereafter, when detecting the restoration from the fuel cut, the E/G_ECU 31 may restart the ignition timing control, the fuel injection control, and the EGR control. A determination as to whether the restoration from the fuel cut is made may be made by the E/G_ECU 31 based on, for example, a degree of accelerator opening θacc detected by the accelerator opening sensor 29. That is, the E/G_ECU 31 may determine that the restoration from the fuel cut is made, when the stepping down of the accelerator pedal is detected, from a state in which the accelerator pedal is released, based on the degree of accelerator opening θacc. In one embodiment of the disclosure, the E/G_ECU 31 may serve as the “controller.”

When the EGR control is restarted by the restoration from the fuel cut, the E/G_ECU 31 may open the EGR primary valve 22a as predetermined, by driving the EGR primary valve actuator 41. When the EGR primary valve 22a opens, the EGR gas in the EGR primary passage 22 is supplied to each cylinder through the air chamber 7a. Because the EGR primary passage 22 immediately after the restoration from the fuel cut is filled with the fresh air, the EGR gas to be supplied to the cylinder includes only the air.

The E/G_ECU 31 may include a processor 31a of corrected torque and EGR secondary valve opening. The processor 31a is configured to obtain a torque correction value and a degree of opening of the EGR secondary valve 23a on the occasion of the restoration from the fuel cut during or after the EGR learning/diagnosis. This leads to alleviation of a torque level difference to be generated by the surplus air to be supplied from the EGR primary passage 22 on the occasion of the restoration from the fuel cut.

When the E/G ECU 31 determines that the restoration from the fuel cut is made, the E/G ECU 31 may obtain, in the fuel injection control, an amount of fuel injection to be injected from the direct injection injector 4 into each cylinder immediately after the restoration from the fuel cut. The amount of fuel injection may be obtained based on the intake pipe pressure detected by the intake pipe pressure sensor 26, the engine speed Neg detected by the engine speed sensor 30, and the like. The E/G_ECU 31 may transmit a signal of the amount of fuel injection to the fuel injection device 43. The fuel injection device 43 may drive the direct injection injector 4 of each cylinder at predetermined timing to cause the fuel injection.

When the ignition timing control is restarted, the E/G_ECU 31 may make a retard control of the ignition timing. In the retard control of the ignition timing, the E/G_ECU 31 may transmit an ignition retard signal to the ignition device 44. The ignition device 44 may retard the ignition timing as predetermined, and output an ignition signal at predetermined ignition timing to the spark plug 5 faced with the cylinder as an ignition target.

When making the fuel injection control and the ignition timing control on the occasion of the restoration from the fuel cut, the E/G_ECU 31 may allow the processor 31a of the corrected torque and the EGR secondary valve opening to calculate the correction torque and the degree of opening of the EGR secondary valve 23a. The correction torque is provided for correction of the amount of fuel injection and the ignition timing on the occasion of the restoration. When the EGR secondary valve 23a opens, a part of the EGR gas is allowed to escape toward the exhaust pipe 11 through the EGR secondary passage 23.

The E/G_ECU 31 may allow the processor 31a to make the calculation by the predetermined number of cycles from the determination that the restoration from the fuel cut is made. It is to be noted that 1 cycle equals 720 (deg). The number of cycles until a combustion gas generated by an initial explosion after the restoration from the fuel cut flows into the combustion chamber as the EGR gas is known in advance. The initial explosion means the first combustion in the cylinder after the restoration from the fuel cut. The calculation of the degree of opening of the EGR secondary valve 23a and corrected torque after the correction of the ignition timing may be made by the number of cycles. Alternatively, the E/G_ECU 31 may monitor changes in the air-fuel ratio detected by the air-fuel ratio sensor 27 from the restoration from the fuel cut, and make the calculation until the air-fuel ratio changes because of the initial explosion.

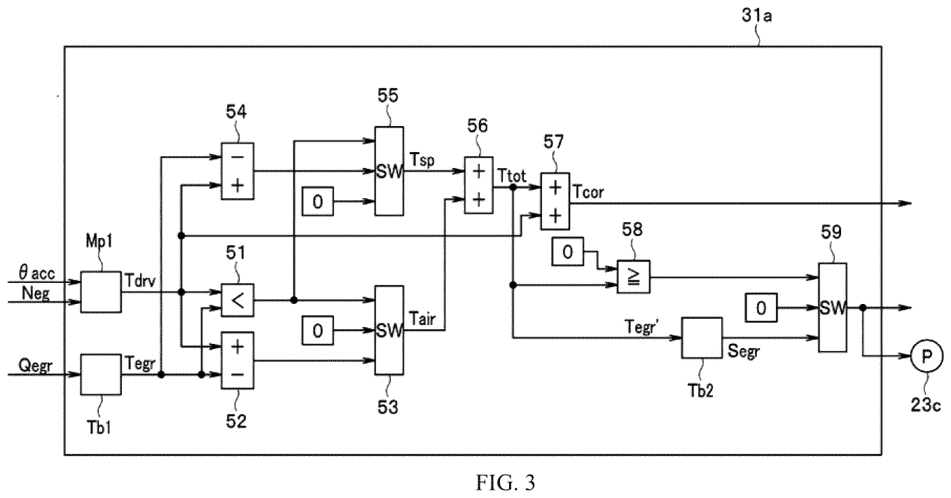

FIG. 3 illustrates a configuration of the processor 31a of the corrected torque and the EGR secondary valve opening. The processor 31a may include a first table searcher Tb1, a second table searcher Tb2, a map searcher Mp1, a first comparator 51, a first subtractor 52, a first switch 53, a second subtractor 54, a second switch 55, a first adder 56, a second adder 57, a second comparator 58, and a third switch 59. In one embodiment of the disclosure, the first table searcher Tb1 may serve as a “surplus torque setter.” In one embodiment of the disclosure, the second table searcher Tb2 may serve as a “valve opening setter.” In one embodiment of the disclosure, the map searcher Mp1 may serve as a “requested torque setter.” In one embodiment of the disclosure, the first comparator 51 may serve as a “comparator.” In one embodiment of the disclosure, the first adder 56 may serve as a “correction torque setter.” In one embodiment of the disclosure, the second adder 57 may serve as a “corrected torque processor.” In one embodiment of the disclosure, the third switch 59 may serve as a “driving signal outputter.”

The first table searcher Tb1 may set surplus torque Tegr (N·m). The surplus torque may be set by referring to a surplus torque table, based on the volume flow rate Qegr (m³/sec), i.e., the air flow rate, of the air to be supplied to the air chamber 7a. The surplus torque Tegr is surplus engine torque to be generated by supplying the air to the combustion chamber from the EGR primary passage 22. Thus, in one embodiment of the disclosure, the first table searcher Tb1 may serve as the “surplus torque setter.”

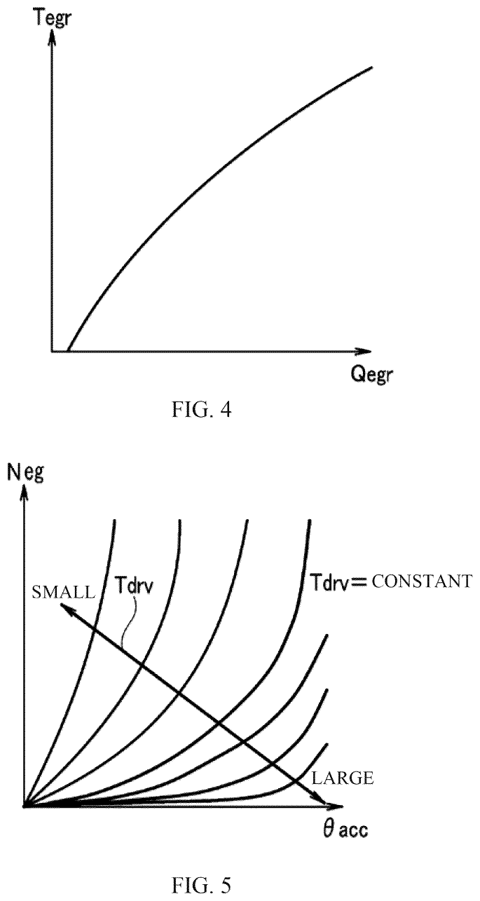

FIG. 4 is a conceptual graph of the surplus torque table. The EGR flow rate Qegr may be set based on the degree of opening, i.e., the number of steps, of the EGR primary valve 22a. The EGR flow rate Qegr and the degree of opening of the EGR primary valve 22a are in proportional relation with a predetermined inclination. Accordingly, the EGR flow rate Qegr may be calculated by a linear expression based on the degree of opening of the EGR primary valve 22a.

As illustrated in FIG. 4, the surplus torque Tegr is in increasing relation with an increase in the EGR flow rate Qegr. The characteristics of the surplus torque table may be obtained and set in advance for each vehicle type from an experiment or the like.

The map searcher Mp1 may refer to a requested torque map based on the degree of accelerator opening θacc and the engine speed Neg, and set engine torque Tdrv (N·m) requested by the driver, i.e., requested torque. FIG. 5 is a conceptual graph of the requested torque map. As illustrated in the figure, when the engine speed Neg becomes higher while the degree of accelerator opening θacc is low, the requested torque Tdrv is small. In contrast, when the engine speed N_{eg} does not increase even when the accelerator pedal is stepped down and the degree of accelerator opening θacc increases, the requested torque Tdrv becomes larger.

The first comparator 51 is configured to make a comparison between the requested torque Tdrv and the surplus torque Tegr. When the requested torque Tdrv is smaller than the surplus torque Tegr (Tdrv<Tegr), the first comparator 51 may output “0.” When the requested torque Tdrv is equal to or larger than the surplus torque Tegr (Tdrv≥Tegr), the first comparator 51 may output “1.” The inequality “Tdrv<Tegr” indicates that the degree of accelerator opening on the occasion of the restoration from the fuel cut is low or medium. The inequality “Tdrv≥Tegr” indicates that the degree of accelerator opening on the occasion of the restoration from the fuel cut is high.

The first subtracter 52 is configured to subtract the surplus torque Tegr from the requested torque Tdrv to calculate a torque level difference “Tdrv−Tegr.” The first subtracter 52 may output the torque level difference “Tdrv−Tegr” to the first switch 53. When “1” is inputted from the first comparator 51 (Tdrv≥Tegr), the first switch 53 may output the torque level difference “Tdrv−Tegr” obtained by the first subtractor 52 as air correction torque Tair (N·m) to the first adder 56. The air correction torque Tair is provided for correction of an amount of the air to pass through the throttle valve 9, i.e., an amount of the throttle-passing air.

When “0” is inputted from the first comparator 51 (Tdrv<Tegr), the first switch 53 may output “0” to the first adder 56. In this case, even if the driver steps down the accelerator pedal on the occasion of the restoration from the fuel cut, the E/G_ECU 31 does not open the throttle valve 9 of the electronically controlled throttle valve.

The second subtracter 54 may subtract the surplus torque Tegr from the requested torque Tdrv to calculate the torque level difference “Tdrv−Tegr.” The second subtracter 54 may output the torque level difference “Tdrv−Tegr” to the second switch 55. When “0” is inputted from the first comparator 51 (Tdrv<Tegr), the second switch 55 may output the torque level difference “Tdrv−Tegr” obtained by the second subtractor 54 as negative ignition correction torque Tsp (N·m) to the first adder 56. On the ignition correction torque Tsp, a limiter may be set in consideration of a misfire limit.

When “1” is inputted from the first comparator 51 (Tdrv≥Tegr), the second switch 55 may set the ignition correction torque Tsp (N·m) to zero (0) and output zero (0) to the first adder 56. In this case, no torque adjustment by the ignition correction torque is made.

The first adder 56 may add the air correction torque Tair to the ignition correction torque Tsp to calculate total correction torque Ttot as the correction torque (Ttot←Tair+Tsp). The first switch 53 may output the air correction torque Tair as the torque level difference “Tdrv−Tegr” only when the first comparator 51 outputs “1” (Tdrv≥Tegr). In contrast, the second switch 55 may output the negative ignition correction torque Tsp as the torque level difference “Tdrv−Tegr” only when the first comparator 51 outputs “0” (Tdrv<Tegr).

Thus, the total correction torque Ttot to be outputted from the first adder 56 may take a value of the air correction torque Tair when the requested torque Tdrv is equal to or larger than the surplus torque Tegr (Tdrv≥Tegr). The total correction torque Ttot may take a value of the ignition correction torque Tsp when the requested torque Tdrv is smaller than the surplus torque Tegr (Tdrv<Tegr).

Accordingly, when the requested torque Tdrv is equal to or larger than the surplus torque Tegr (Tdrv≥Tegr), the degree of opening of the throttle valve 9 may be corrected, i.e., air-corrected, to alleviate a torque shock on the occasion of the restoration from the fuel cut. When the requested torque Tdrv is smaller than the surplus torque Tegr (Tdrv<Tegr), the ignition timing may be subjected to the retard control, i.e., ignition-corrected, based on the ignition correction torque Tsp to reduce the torque shock on the occasion of the restoration from the fuel cut.

The second adder 57 may add the total correction torque Ttot to the requested torque Tdrv, calculate corrected torque Tcor (N·m), and output a value of the corrected torque Tcor.

The E/G_ECU 31 may correct the amount of the intake air and the ignition timing based on the corrected torque Tcor (N·m) from the second adder 57. The E/G ECU 31 may output a throttle position signal corresponding to the corrected amount of the intake air to the throttle actuator 9a. At the same time, the E/G_ECU 31 may output a signal of the corrected ignition timing to the ignition device 44.

The throttle actuator 9a may increase the degree of opening of the throttle valve 9 as predetermined in accordance with the throttle position signal inputted from the E/G_ECU 31. The ignition device 44 may retard the ignition timing of the spark plug 5 of the cylinder as the ignition target in accordance with the signal of the ignition timing inputted from the E/G ECU 31.

The second comparator 58 may check whether the total correction torque Ttot is equal to or larger than “0.” When the total correction torque Ttot is smaller than or equal to “0”, that is, when the total correction torque Ttot is negative (Ttot≤0), the second comparator 58 may output zero (0) to the third switch 59. When the total correction torque Ttot is larger than “0”, that is, when the total correction torque Ttot is positive (Ttot>0), the second comparator 58 may output “1” to the third switch 59. When the inequality Ttot>0 is satisfied, there is possibility that actual torque becomes larger than the requested torque Tegr even if the E/G_ECU 31 sets the amount of the air to pass through the throttle valve to idle (fully closed) based on the correction torque Tcor and makes retard correction of the ignition timing to the misfire limit.

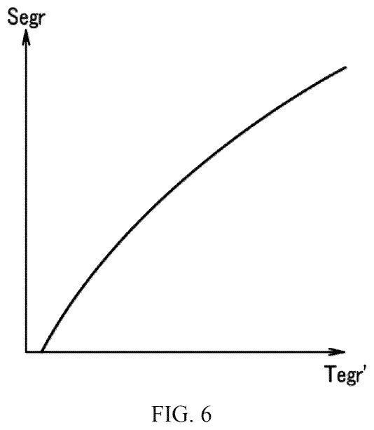

The second table searcher Tb2 may set the total correction torque Ttot as corrected surplus torque Tegr′. The second table searcher Tb2 may refer to an EGR secondary valve opening table based on the corrected surplus torque Tegr' to set the degree of opening of the EGR secondary valve 23a. FIG. 6 is a conceptual graph of the EGR secondary valve opening table. The EGR secondary valve opening table may be obtained by converting the surplus torque into an air flow rate (m³/sec), and obtaining and setting, in advance for each vehicle type from an experiment or the like, a degree of valve opening, i.e., the number of steps, corresponding to the air flow rate. As illustrated in the figure, the degree of opening Segr of the EGR secondary valve 23a, i.e., the EGR secondary valve opening, is in increasing relation with an increase in the corrected surplus torque Tegr′.

When “0” is inputted from the second comparator 58, the third switch 59 may maintain the EGR secondary valve opening at “0.” That is, the third switch 59 may keep the EGR secondary valve 23a closed. When “0” is inputted from the second comparator 58, that is, when the inequality Ttot≤0 is satisfied, it is possible to bring the actual torque to substantially the requested torque Tegr, by correcting the amount of the throttle-passing air based on the correction torque Tcor and making the retard control of the ignition timing based on the correction torque Tcor.

When “1” is inputted from the second comparator 58 (Ttot>0), the third switch 59 may read the degree of opening Segr of the EGR secondary valve 23a set by the second table searcher Tb2, and output a corresponding driving signal to the EGR secondary valve actuator 42. At the same time, the third switch 59 may output a pump driving signal to the electric pump 23c provided on the EGR secondary passage 23.

The EGR secondary valve actuator 42 may open the EGR secondary valve 23a as predetermined based on the driving signal from the E/G_ECU 31. Thereupon, the EGR secondary valve 23a may open with the degree of opening corresponding to the air flow rate (m³/sec) set by converting the corrected surplus torque Tegr′. As a result, the surplus air in the EGR primary passage 22 passes through the EGR secondary passage 23 by the driving of the electric pump 23c, and is discharged directly upstream of the exhaust purification catalyst 12 on the exhaust pipe 11.

Thus, on the occasion of the restoration from the fuel cut during which the EGR learning/diagnosis is made, the excessive air supply to the air chamber 7a from the EGR primary passage 22 is suppressed. This helps to bring the actual torque to substantially the requested torque Tdrv without retarding the ignition timing to the misfire limit. Hence, it is possible to alleviate the torque level difference because of the sudden rise in the engine torque immediately after the restoration from the fuel cut.

The surplus air is discharged directly upstream of the exhaust purification catalyst 12, and the surplus air is supplied to the exhaust purification catalyst 12 and the GPF 13. This helps to utilize the surplus air as an oxidizing agent that promotes oxidation of CO (carbon monoxide), HC (hydrocarbon), and PM (particulate matters).

According to the embodiment of the disclosure, during the learning/diagnosis of the EGR device during the fuel cut, or on the occasion of the restoration from the fuel cut after the learning/diagnosis of the EGR device, the requested torque as the engine torque requested by the driver on the occasion of the restoration from the fuel cut is set. The surplus torque in combustion is set based on the flow rate of the air to pass through the EGR valve. The correction torque is set based on a result of the comparison between the requested torque and the surplus torque. The correction torque is provided for the correction of the amount of the air to pass through the throttle valve and the retard correction of the ignition timing. Such torque correction helps to bring the actual torque on the occasion of the restoration from the fuel cut to substantially the requested torque. This results in alleviation of the torque level difference because of the sudden rise in the engine torque on the occasion of the restoration from the fuel cut during which the EGR learning/diagnosis is made, leading to reduction in the torque shock to be felt by the driver.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, an engine to be employed is not limited to a direct injection engine but may include a port injection engine or a diesel engine.

The E/G ECU 31 illustrated in FIG. 2 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the E/G ECU 31. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the E/G ECU 31 illustrated in FIG. 2.

1. An engine controller comprising:
an exhaust gas recirculation valve provided on an exhaust gas recirculation passage in an exhaust gas recirculation device, the exhaust gas recirculation passage serving as a bypass between an exhaust passage and an intake passage of an engine;
a fuel injection device configured to inject fuel into a cylinder of the engine;
an ignition device configured to ignite, at predetermined ignition timing, a spark plug of the engine faced with an inside of the cylinder; and
a controller configured to
compulsively open and close the exhaust gas recirculation valve during fuel cut, to perform learning and diagnosis of the exhaust gas recirculation device,
detect restoration from the fuel cut, and
on an occasion of the restoration from the fuel cut, make a retard control of the ignition timing, a control of an amount of air to pass through a throttle valve, and a control of a degree of opening of the exhaust gas recirculation valve,
the controller comprising a processor configured to calculate torque on the occasion of the restoration from the fuel cut during or after the learning and the diagnosis of the exhaust gas recirculation device,
the processor comprising
a requested torque setter configured to, on the occasion of the restoration from the fuel cut, set requested torque as engine torque requested by a driver,
a surplus torque setter configured to, on the occasion of the restoration from the fuel cut, set surplus torque in combustion based on a flow rate of air to pass through the exhaust gas recirculation valve,
a comparator configured to make a comparison between the requested torque set by the requested torque setter and the surplus torque set by the surplus torque setter, and
a correction torque setter configured to set, based on a result of the comparison by the comparator, correction torque to correct the amount of the air to pass through the throttle valve and to make retard correction of the ignition timing.

2. The engine controller according to claim 1, wherein
the correction torque setter is configured to,
when the comparator determines that the requested torque is larger than the surplus torque, set the correction torque to a value obtained by subtracting the surplus torque from the requested torque, and correct the amount of the air to pass through the throttle valve based on the correction torque, and
when the comparator determines that the requested torque is smaller than the surplus torque, make the retard correction of the ignition timing based on the correction torque.

3. The engine controller according to claim 2, wherein
the processor further comprises a corrected torque processor configured to add the correction torque set by the correction torque setter to the requested torque set by the requested torque setter, to calculate corrected torque, and
the controller is configured to, based on the corrected torque calculated by the corrected torque processor, set the ignition timing and a degree of opening of the throttle valve on the occasion of the restoration from the fuel cut.

4. The engine controller according to claim 1, wherein
the exhaust gas recirculation device further comprises
an exhaust gas recirculation secondary passage, and
an exhaust gas recirculation secondary valve provided on the exhaust gas recirculation secondary passage,
the exhaust gas recirculation secondary passage comprises
a downstream end communicating directly upstream of an exhaust gas purification catalyst provided on the exhaust passage, and
an upstream end communicating with a downstream portion of the exhaust gas recirculation passage,
the processor further comprises
a valve opening setter configured to set a degree of opening of the exhaust gas recirculation secondary valve corresponding to the amount of the air corrected based on the correction torque, and
a driving signal outputter configured to output a driving signal to open the exhaust gas recirculation secondary valve with the degree of opening set by the valve opening setter.

5. The engine controller according to claim 4, wherein
the exhaust gas recirculation device further comprises a pump provided on the exhaust gas recirculation secondary passage and configured to discharge air inside the exhaust gas recirculation secondary passage toward the exhaust passage, and
the driving signal outputter is configured to open the exhaust gas recirculation secondary valve and output a pump driving signal to the pump.

6. An engine controller comprising:
an exhaust gas recirculation valve provided on an exhaust gas recirculation passage in an exhaust gas recirculation device, the exhaust gas recirculation passage serving as a bypass between an exhaust passage and an intake passage of an engine;
a fuel injection device configured to inject fuel into a cylinder of the engine;
an ignition device configured to ignite, at predetermined ignition timing, a spark plug of the engine faced with an inside of the cylinder; and
circuitry configured to
compulsively open and close the exhaust gas recirculation valve during fuel cut, to perform learning and diagnosis of the exhaust gas recirculation device,
detect restoration from the fuel cut, and
on an occasion of the restoration from the fuel cut, make a retard control of the ignition timing, a control of an amount of air to pass through a throttle valve, and a control of a degree of opening of the exhaust gas recirculation valve,
the circuitry being configured to
calculate torque on the occasion of the restoration from the fuel cut during or after the learning and the diagnosis of the exhaust gas recirculation device,
on the occasion of the restoration from the fuel cut, set requested torque as engine torque requested by a driver,
on the occasion of the restoration from the fuel cut, set surplus torque in combustion based on a flow rate of air to pass through the exhaust gas recirculation valve,
make a comparison between the requested torque and the surplus torque, and
set, based on a result of the comparison, correction torque to correct the amount of the air to pass through the throttle valve and to make retard correction of the ignition timing.
